(19) United States
(12) Patent Application Publication
(10) Pub. No.: US 2002/0194260 A1
(43) Pub. Date: Dec. 19, 2002

(54) METHOD AND APPARATUS FOR CREATING MULTIMEDIA PLAYLISTS FOR AUDIO-VISUAL SYSTEMS

(76) Inventors: KENT LAWRENCE HEADLEY, SAN JOSE, CA (US); MASAHIRO NAKANO, LOS ALTOS, CA (US); ROLF HENRI TOFT, SAN FRANCISCO, CA (US); ROBERT BRADLEY ROSIN, BOSTON, MA (US); TOSHIYA FUJII, MENLO PARK, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/235,315

(22) Filed: Jan. 22, 1999

(51) Int. Cl. G06F 15/16

(52) U.S. Cl. 709/203

(57) ABSTRACT

A method executed in a data processing system is provided for generating a list of media for playback from different types of audio and video media. Initially, a list of different types of media available for playback is identified. Based on the identification, the list of media is displayed. Using this list of media, a multimedia playlist is created including audio and video media from the list of media. Another aspect of the present invention provides a method for playing different types of audio and video media on different audio and video devices. Initially, a multimedia playlist having a list of audio and video media is loaded. The first entry of media in the multimedia playlist is selected for playback. This first entry of media is processed and played back on a device compatible with the first entry of media. A subsequent entry of media in the multimedia playlist is also selected for playback. This subsequent entry of media is processed and played back on a device capable of processing the subsequent entry of media.

### RELATED APPLICATION

This application relies upon and incorporates by reference, U.S. patent application No. ______, entitled “Method and Apparatus for Synchronizing Playback of Multiple Media Types over Networks Having Different Transmission Characteristics,” bearing attorney docket no. 07095.0016-00000, filed on the same date herewith.

### BACKGROUND ART

1. Technical Field

This invention generally relates to multimedia systems and more particularly, to a method and apparatus for creating multimedia playlists for audio-visual systems.

2. Description of the Related Art

Conventional audio-video systems are designed to play audio and video information from a variety of different media. These systems include audio devices that can playback sounds from audio media such as compact disks (CD), minidisks, tape cassettes, and records. The video devices on these systems can display images on a display screen such as a television set and generate accompanying voice, music, or sound. Video information can be stored on video media such as video cassettes, digitally encoded laser disks, and digital video display (DVD) disks.

With advances in technology, users expect audio-video systems that are moderately priced yet replete with features. They want more control over how audio and video media are played on these systems than provided today. Currently, audio-video systems use devices that are programmed independently. A user can store a small program in the device instructing the device to play tracks on audio or video media in a predetermined order. For example, a user can program a compact disk (CD) player to play selected audio tracks on a CD in a particular order. On some compact disk systems, the user can select that the CD player plays tracks in a random order. Video devices operate in a similar manner. If a user wants to record a television broadcast, video devices can be programmed to start and stop recording at predetermined times.

While many of these audio and video devices can be programmed, they still operate as individual playback devices. Existing audio-video systems do not allow the user to coordinate the playback of audio and video media on separate devices. An audio device in an audio-video system plays audio material but cannot be synchronized with video and sound being played by a video device such as a laser disk player. This lack of coordination between audio-video devices prevents users from combining audio, video, and images available on different devices. For example, users can not select a sequence of songs from a CD and combine them with a sequence of songs from a minidisk.

Some CD players have enhanced the playback of tracks on a CD by displaying additional information about the particular song or track on the CD. This additional information can be used to assist the user in selecting the sequence of tracks to playback on a CD player device. This additional information is contained in a database connected to a network such as the Internet and includes audio information such as a title, the performers names, and the playing time of each track on a CD. U.S. patent application Ser. No. 08/507,544 “Compact Disk Changer Utilizing Disk Data Base,” filed Jul. 26, 1995 by Carl J. Yankowski and assigned to the assignee of the present invention, discusses a CD player capable of downloading such additional information from a remote database on a network. This information is then displayed on a display panel of a high-capacity CD player device. This patent, however, does not disclose a method for combining audio and video from different media types for playback on an audio-video system.

With access to the Internet, there are many types of additional information users can combine with audio and video media. Often, clipart, images, digitally stored sound, and video are available on the Internet for free or a small charge. Currently, conventional audio-video systems don't combine multiple media types with information available on the Internet. For example, existing audio-video systems do not display a selectable hypertext link on a display device when a particular song or video is being played on the audio-video systems. It is therefore desirable to create an audio-video system that a user can program to play multiple media from different audio and video devices in addition to combining this media with information separately from a network such as the Internet.

### DISCLOSURE OF THE INVENTION

In accordance with the present invention, as embodied and broadly described herein, a method for generating a list of media for playback from different types of audio and video media is provided. Initially, a list of different types of media available for playback is identified. Based on the identification, the list of media is displayed. Using this list of media, a multimedia playlist is created including audio and video media from the list of media.

Another aspect of the present invention provides a method for playing different types of audio and video media on different audio and video devices. Initially, a multimedia playlist having a list of media is loaded. The media can be located on different devices or located on a remote computer connected to the audio and video devices over a network. The first entry of media in the multimedia playlist is selected for playback. This first entry of media is processed and played back on a device compatible with the first entry of media. A subsequent entry of media in the multimedia playlist is also selected for playback. This subsequent entry of media is processed and played back on a device capable of processing the subsequent entry of media. The multimedia playlist facilitates playback of media from many different devices.

### BRIEF DESCRIPTION OF THE DRAWINGS

The accompanying drawings, which are incorporated in and constitute a part of this specification, illustrate systems and methods consistent with the invention and, together with the description, serve to explain the advantages, and principles of the invention.

In the drawings:

FIG. 1 is a block diagram of an audio-video system consistent with the present invention including a server having an audio and video database;

FIG. 2 is a block diagram of a set-top device shown in FIG. 1 consistent with the present invention;

FIG. 3. is a block diagram illustrating a multimedia playlist consistent with the present invention;

FIG. 4 is a flow chart of the method steps for creating a multimedia playlist consistent with the present invention;

FIG. 5 is a flowchart diagram illustrating the steps associated with processing multimedia playlist in accordance with the present invention; and

FIG. 6 is a block diagram displaying a multimedia playlist on a graphical user interface in consistent with the present invention.

### BEST MODE FOR CARRYING OUT THE INVENTION

### Audio Visual System And Network

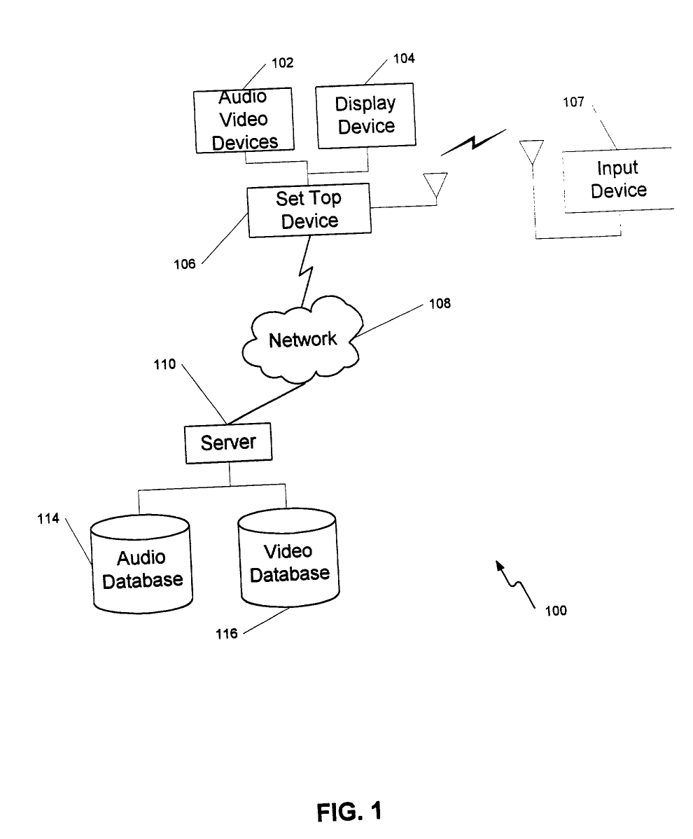

FIG. 1 is a block diagram of an audio-video system 100 operatively coupled to a network capable of combining various media into a multimedia presentation. Audio-video system 100 includes audio-video devices 102, a display device 104, a set-top device 106, and an input device 107 for communicating with set-top device 106, a network 108 accessible by set-top device 1 06, and a server 110 with audio and video information in an audio database 114 and video database 116 respectively. Network 108 may also include the Internet and resources associated with the Internet.

Audio-video devices 102 includes devices capable of playing different audio and video media. These devices include a compact disk player, a video tape player, a digital video device (DVD), a mini disk player, and an audio receiver. These devices are connected together using a bus such as IEEE-1394 or Universal Serial Bus (USB). Because each device connected to the bus can be uniquely addressed, multiple identical devices can be configured into the same system. For example, two digital video display (DVD) devices could be separately addressed on the bus as DVD-1 and DVD-2.

Video is displayed on display device 104 when there is video to display in addition to the audio. A television tuner or playback device in audio-video devices 102 generates images displayed on display device 104. Display device 104 can be any device used to display images such as a computer screen, a television, or a video monitor device.

Set-top device 106 is a computer-based device connected over a network 108 to a server 110 and a server 112. Network 108 preferably comprises the Internet, but other networks may of course be used. Set-top device 106 operates as an interface between audio-video devices 102, display device 104, and server 110. A communication protocol enables set-top device 106 to communicate with audio-video devices 102 and display device 104. Set-top device 106 sends commands to audio-video devices 102 to play audio and video media in accordance with the present invention. These commands can be in the format of the control protocol called Control A-1 or S-Link developed by the Sony Corporation based in Tokyo, Japan. Alternatively, other control protocols can be used that are compatible with audio-video devices 102.

Input device 107 can communicate with set-top device 106 through a wireless communication mechanism using infrared signals or radio frequency signals. This allows a user to operate set-top device 106 and accompanying audio-video devices 102 without cumbersome wires. Input device 107 can be a keyboard, a keyboard and a mouse, a hand-held remote control device, or any other input device useful in controlling set-top device 106.

In FIG. 1, server 110 has access to both an audio database 114 and a video database 116. Audio database 114 stores audio information related to audio media played back on an audio device in audio-video devices 102. For example, audio database 114 may include the names of songs on a CD, title of the CD, musicians names playing each title, and may also include a hypertext link on the Internet where additional information about the CD. Server 110 transmits audio information through network 108 to set-top device 106. Set-top device 106 stores the audio information internally on a storage device such as a hard disk.

Likewise, video database 116 can provide video information corresponding to video media played on a video device in audio-video devices 102. Similar to the audio information, server 110 transmits the video information through server 110 and network 108 to set-top device 106. Set-top device 106 can also store video information on the same type of storage devices used to hold audio information. Video information can include the title of a video, length of time for playing a video, and hypertext links on the Internet with information related to a video or links to other related media. Those skilled in the art will appreciate that audio database 114 and video database 116 can be connected to the same server as well as multiple servers and this particular configuration has been provided as only one example.

Set-top device 106 plays audio and video media in accordance with a user defined multimedia playlist. The multimedia playlist list indicates the sequence for playing audio and video media stored on audio-video devices 102. Additional information on generating this multimedia playlist in accordance with the present invention is discussed later herein.

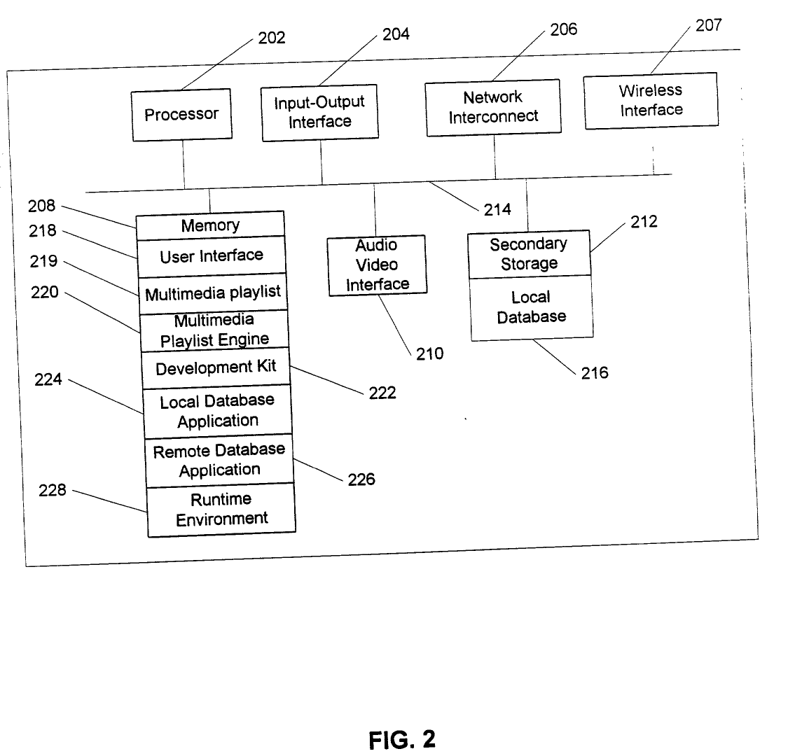

FIG. 2 is a block diagram of set-top device 106 designed in accordance with the present invention. Set-top device 106 includes a processor 202, an input-output interface 204, a network interconnection 206, a wireless interface 207, a memory 208, an audio-video interface 210, a secondary storage 212, and a bus 214 facilitating communication between each of the aforementioned elements. Processor 202 can be a general purpose processor such as an Intel Pentium processor or an application specific integrated circuit (ASIC) designed to execute one or more applications. For example, processor 202 can be an ASIC designed specifically to run web browser software compatible with the World Wide Web (WWW). Input-output interface 204 can be connected to a number of different peripheral devices such as an external storage device or a printer. Network interconnect 206 may be a modem, cable modem, or other device to provide an interface between a network such as the Internet and set-top device 106. Wireless interface 207 facilitates receiving infra-red (IR) or radio frequency (RF) signals from input devices not physically attached to set-top device 106. For example, a keyboard device and mouse can communicate with set-top box 106 through an infrared wireless interface without the use of cables or other physical attachments.

Memory 208 includes a user interface 218, a multimedia playlist 219, a multimedia playlist engine 220, a development kit 222, a local database application 224, a remote database application 226, and a run time environment 228. User interface 218 is a graphical user interface supporting hypertext links and suitable for displaying and controlling the playback of multiple media types in accordance with the present invention. Preferably, user interface 218 is a web browser capable of displaying and controlling video, audio, and providing hypertext links to other locations on the World Wide Web (WWW).

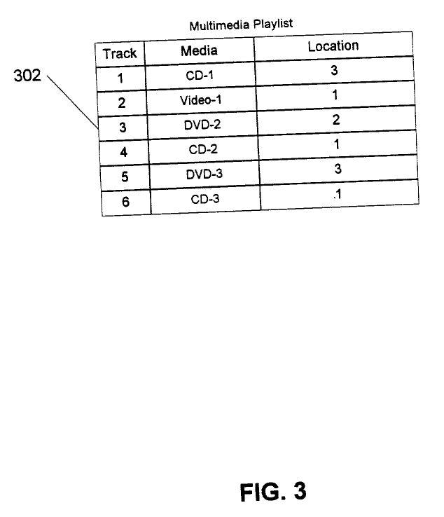

Multimedia playlist 219 includes a list of audio and video media to play on devices in audio-video devices 102. Referring to FIG. 3, a block diagram illustrates an exemplary multimedia playlist 302. In this example, multimedia playlist 302 includes six different entries of video and audio media including the particular location on the media to play. If a media such as a CD has multiple tracks then the location column in the entry indicates the track to play on the CD. Similarly, if the media does not use multiple tracks then the location column corresponding to the media may have an entry of one.

Each entry in the multimedia playlist 302 is played in sequence. For example, the first entry corresponds to track 3 of the CD loaded in CD player “CD-1”. After the first entry is played, the video cassette in video device “Video-1” is played corresponding to the second entry in multimedia playlist 302. Multiple devices used to play the same media type are uniquely identified with labels such as CD-1 and CD-2. This allows multimedia playlist 302 to address media used in different media devices which play the same type of media. In this case, multimedia playlist 302 addresses the CDS in three different CD players labeled CD-1, CD-2, and CD-3.

Referring back to FIG. 2, multimedia playlist engine 220 sends commands to different audio and video devices to play different media. Preferably, multimedia playlist engine 220 processes multimedia playlist 219 to generate these commands. Multimedia playlist engine 220 can be implemented in C, JavaScript, or an object-oriented programming language such as the Java programming language. For security reasons, standard versions of the Java programming language and the JavaScript scripting language do not generally allow applications to access storage spaces and system resources associated with a computer system. Consequently, multimedia playlist engine 220 uses special extensions to JavaScript or the Java Programming language to access secondary storage 212, memory 208, and other storage areas where multimedia playlist 219 and related information may be stored.

In operation, multimedia playlist engine 220 determines what media is available on each device in audio-video devices 102. Display device 104 displays a list of the available audio and video media on audio-video system 100. Additional information related to each available media such as a title and the time to play the media may also be downloaded from network 108 and displayed on display device 104. Using multimedia playlist engine 220, a user selectively combines the various media into a multimedia playlist 219. Later, multimedia playlist engine 220 processes multimedia playlist 219 coordinating the playback of media on selected audio-video devices 102.

Development kit 222 includes software libraries and application programming interfaces (APIs) used by multimedia playlist engine 220 to access audio and video media information stored on local databases, remote databases, and other storage areas associated with set-top box 106. Development kit 222 provides access using a protocol such as Sony's Control A-1 or S-Link protocol to send commands to audio-video devices 102 and control home audio-video equipment. These software libraries and APIs in development kit 222 may be compatible with a wide range of programming languages including C, JavaScript, the Java programming language and other object-oriented programming languages. Special extensions to hypertext markup language (HTML) and user interface 218 are capable of processing audio and video information from audio and video media in a web browser type interface.

Local database application 224 and remote database application 226 store information related to audio and video media. This information can be displayed to the user and may assist the user in selecting which media to include in multimedia playlist 219. For example, this information may indicate that name of a person performing on a song on a CD or the length of time it takes to play a song on the CD. Information can be downloaded from a remote database using remote database application 226 and stored in local database 216. Thereafter, this additional information on the media is accessed in local database 216 using local database application 224. If no additional information on a particular media is available on local database 216 or a remote database then only information actually stored on the media can be displayed. For example, an audio media such as a CD may include information such as the number of tracks on the CD or the total playback time of the music on the CD.

Run time environment 228 facilitates execution of the above mentioned software subsystems located in memory 208 on processor 202. Different run time environments 228 compatible with implementations of the present invention include real-time operating systems (RTOS) for real-time processing, UNIX-based operating systems, or Microsoft Windows.

Audio-video interface 210 provides a connection to audio-video devices 102 and display device 104. Set-top device 106 transmits commands through audio-video interface 210 to the appropriate devices in audio-video devices 102 in accordance with the present invention. These commands control operation of each device in audio-video devices 102. For example, audio-visual interface 210 can generate commands requesting the devices to send information on media stored in each device. These commands can also include instructions that cause the audio and video devices to play audio and video media in a desired sequence.

Secondary storage 212 preferably comprises a hard disk drive or other mass storage device to store information such as a local database 216. Local database 216 can be used as a cache for storing hypertext link locations, video clips, and audio or video information downloaded from a remote database.

### Multimedia Playlist

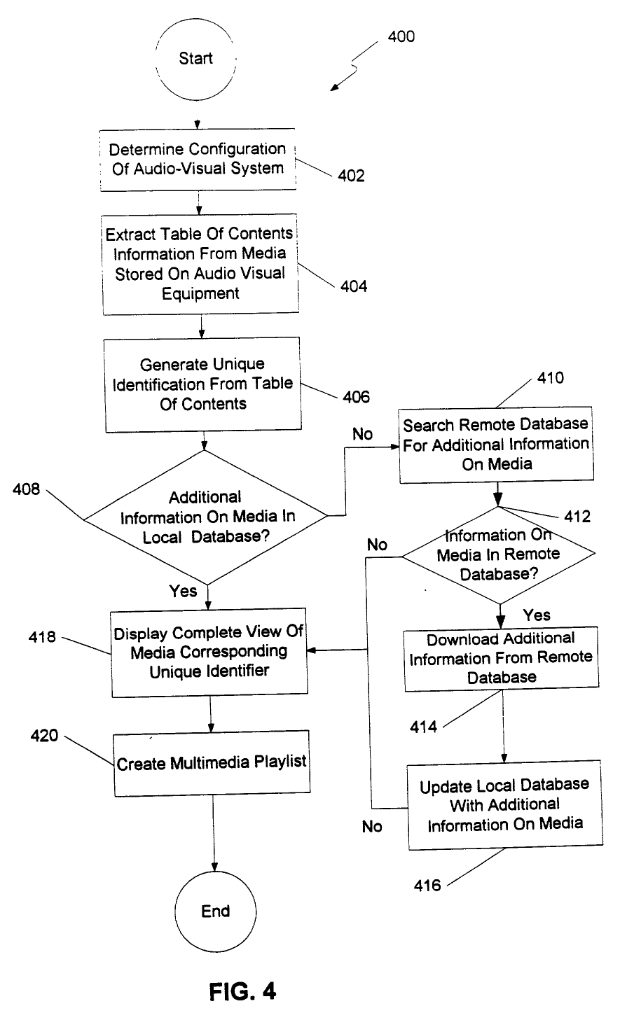

FIG. 4 is a flow chart of the method steps for creating multimedia playlist 219 in accordance with the present invention. Initially, set-top box 106 executes multimedia playlist engine 220 to create multimedia playlist 219. Set-top box 106 sends commands to audio-video devices 102 to determine which devices are available and the configuration of audio-video system 100 (step 402). Set-top box device 106 identifies each audio-video device according to a unique address. Because each audio or video device has a unique address, set-top device 106 can distinguish between multiple audio-video devices that play the same media format. For example, set-top device will identify two CD players as CD-1 and CD-2.

Set-top device 106 uses the unique address associated with each audio-video device to interrogate audio-video devices 102 and identify the media stored on each device. Preferably, the commands used to perform this interrogation are based on the Control A-1 or S-Link protocol developed by the Sony Corporation. In particular, set-top device 106 extracts table of contents information from media stored on each audio-video device (step 404). The table of contents can be used as a “fingerprint” to uniquely identify each media because the table of contents for different media is generally unique. One technique for identifying audio CDS is contained in a specification known in the industry as the “Red Book”. Additional techniques for identifying CDS is also described in U.S. Patent entitled “Compact Disc Changer Utilizing Disc Database”, Ser. No. 08/507,544, by Carl J. Yankowski, assigned to the assignee of the present invention, filed Jul. 26, 1995 which is incorporated by reference in its entirety. Those skilled in the art will appreciate that the techniques for identifying CDS can also be used to identify video and other media such as DVD and minidisks.

Accordingly, set-top device 106 uses table of contents information extracted from the media stored on each audio-video device to generate a unique identifier (step 406). This unique identifier is used to identify a unit of media such as a CD with several song tracks. The unique identifier is then used to cross-reference additional information related to the media which may be located on local database 216 associated with set-top device 106 or a remote database such as audio database 114 or video database 116. These databases include information about the media such as the title, the number of tracks if multiple tracks are on the media, the name of people singing or acting on the media, and the total elapsed time to play the media. Each remote database may also include additional information such as hypertext links, short video clips, and images related to the media. In an alternative embodiment, the unique identifier can be generated on a server machine operatively coupled to set-top device 106 over a network. This would reduce the processing requirements on set-top device 106 and potentially increase performance of the overall system.

Initially, set-top device 106 searches local database 216 to determine if additional information on the media is present that corresponds to the unique identifier (step 408). If additional information is stored on local database 216, this information is included with a complete display of media available on audio-video devices 102 (step 418).

If no additional information matches the unique identifier on local database 216, set-top device 106 then searches the remote databases for additional information (step 410). Set-top device 106 locates additional information in the remote databases corresponding to the media's unique identifier (step 412). If located, the additional information stored in the remote database is downloaded by set-top device 106 (step 414). Once the download is complete, set-top device 106 updates local database 216 for subsequent access and use (step 416). Alternatively, if set-top device 106 does not discover additional media information in a remote database (step 412), then local database 216 is not updated because additional media does not exist.

Set-top device 106 displays a list of media on audio-video devices 102 and related information available over the network (step 418). If no additional information can be located on local database 216 or the remote databases then additional information associated with the media is not displayed on display device 104. This display of media is preferably shown in a graphical user interface such as a browser and allows a user to select audio and video media for use in multimedia playlist 219.

Set-top device 106 enables the user to combine these media together into multimedia playlist 219 (step 420). In one implementation, the user can selectively pick and choose which media to include in multimedia playlist 219. Alternatively, set-top device 106 may randomly select media to create multimedia playlist 219. In either case, multimedia playlist 219 is processed by multimedia playlist engine 220 which causes the media devices to play selected media in the desired sequence.

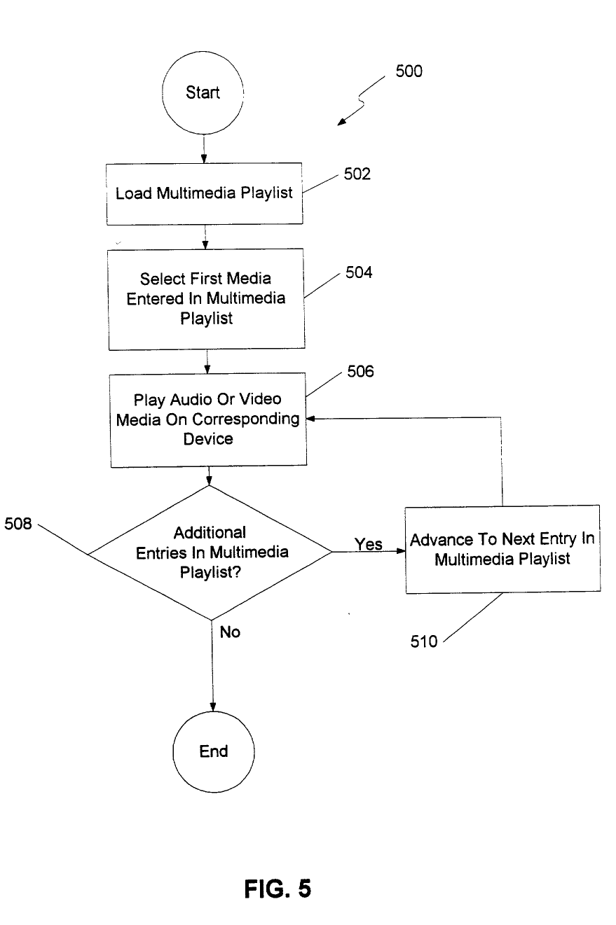

FIG. 5 is a flowchart diagram illustrating the steps associated with processing multimedia playlist in accordance with the present invention. Initially, set-top device 106 loads multimedia playlist 219 in memory 208 for processing by multimedia playlist engine 220 (step 502). Next, multimedia playlist engine 220 selects the first media entered in multimedia playlist 502 for playback (step 504). The device holding the media is located and instructed to play the audio or video media (step 506). If additional entries in multimedia playlist 219 exist (step 508), set-top device 106 advances to the next entry in multimedia playlist 219 (step 510). Set-top device 106 continues to send commands to different audio or video devices that cause them to playback different media. Playback of media in multimedia playlist 219 completes when the sequence of entries in the playlist have been played (step 508).

### Multimedia Playback Using Multimedia Playlist

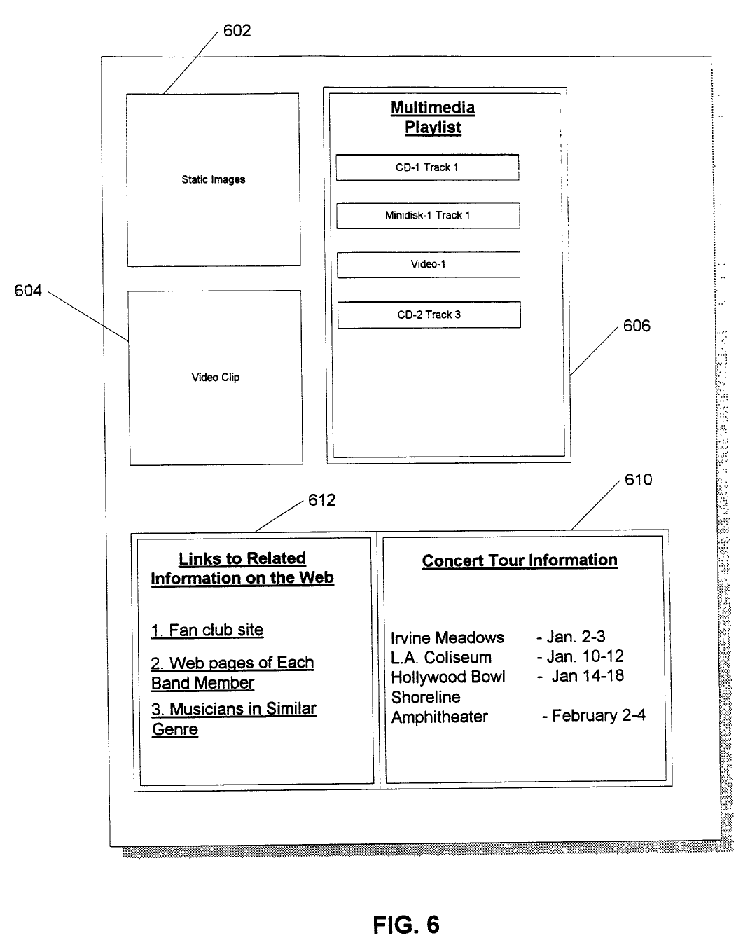

FIG. 6 is a block diagram depiction of a multimedia playback designed in accordance with the present invention and presented on display device 104. This multimedia playback in FIG. 6 is only one example that can be developed in accordance with the present invention. Although numerous specific examples are shown in FIG. 6, variations, combinations, and additional examples not included in FIG. 6 are contemplated to be covered by implementations of the present invention.

This particular multimedia playback includes a static image 602, a video clip 604, a multimedia playlist 606, a list of time-sensitive hypertext links 610 corresponding to the selected media, and a set of static links 612 to information on the web. In this example, assume a user has created a multimedia playlist 606. The user executes multimedia playlist 606 on multimedia playlist engine 220 to play a sequence of media. In this example, the sequence of media includes playing track 1 from CD-1, track 1 from minidisk-1, the video stored in video-1, and track 3 from CD-2.

Multimedia playlist engine 220 may cause display 104 to display additional information related to each entry in multimedia playlist 606 including static images, video clips, and hypertext links. This information can be downloaded and stored in local database 216 along with information on each media such as the title of the media and artists performing the music or acting on the media. Static image 602 can display an image corresponding to the album cover of a CD or video. Alternatively, static image 602 can present a series of static images displayed at certain time intervals like a slideshow while a selected CD is played. Video clip 604 can be a music video created by the same artist on the CD. Typically, this information is compressed for storage on local database 216.

Some hypertext links may correspond to time sensitive information. Accordingly, information in time-sensitive hypertext links 610 can change over time. For example, time-sensitive hypertext links 610 can include a concert tour associated with a band including the location and the date of each concert. These hypertext links may have an expiration date associated with them to make sure they are kept current. Alternatively, these links can be updated at predetermined time intervals such as once a week. In this example, the Irvine Meadows concert information may be erased after January 3rd since the event will have already occurred.

Static links 612 to information on the Web provide connections to other areas of interest that relate to the particular media. Unlike time-sensitive hypertext links 610, static links 612 do not expire or change over time. In this example, links 612 include a fan club site, web pages of each band member, and other musicians in similar genre.

While specific embodiments have been described herein for purposes of illustration, various modifications may be made without departing from the spirit and scope of the invention. For example, implementations of the present invention have been described using audio and video media, however multimedia playlists may also include many other types of media capable of being played back on a device, even though the exact media type has not been discussed herein. It should also be understood that although implementations of the present invention are used in a set-top box, alternative implementations could be integrated into many other types of devices. Further, although aspects of the present invention are described as being stored in memory and other storage mediums, one skilled in the art will appreciate that these aspects of the present invention can also be stored on or read from other types of computer-readable media, such as secondary storage devices, like hard disks, floppy disks, or CD-ROM; a carrier wave from the Internet, or other forms of RAM. Accordingly, the invention is not limited to the above described embodiments, but instead is defined by the appended claims in light of their full scope of equivalents.

1. A method, performed in a data processing system, of generating a list of media for playback from different types of audio and video media, the method comprising the steps of:
identifying a list of different types of media available for playback;
displaying the list of media; and
receiving selections of media from the list of media for playback of audio and video.

2. The method of claim 1 wherein the step of identifying a list of different types of media further comprises the steps of:
determining what devices are associated with the data processing system;
extracting unique data from media loaded in the devices; and
generating an identifier from the unique data associated with each media.

3. The method of claim 2 further comprising the step of locating additional information associated with each media based upon the identifier.

4. The method of claim 3 wherein the additional information includes a title of the media.

5. The method of claim 3 wherein the additional information includes a list of people associated with data provided by the media.

6. The method of claim 3 wherein the step of displaying the list of media also includes displaying the additional information associated with each media.

7. A method, performed in a data processing system, for playing media from different types of audio and video media, the method comprising the steps of:
loading a multimedia playlist having a list of audio and video media;
receiving a selection for a first entry of media in the multimedia playlist for playback;
playing the first entry of media on a device capable of processing the first entry of media;
receiving a selection for a subsequent entry of media in the multimedia playlist for playback; and
playing the subsequent entry of media on a device capable of processing the subsequent entry of media.

8. The method of claim 7 further comprising the step of displaying selectable hypertext links corresponding to an entry of media.

9. The method of claim 7 further comprising the step of displaying video clips corresponding to an entry of media.

10. The method of claim 7 further comprising the step of displaying images corresponding to an entry of media.

11. A data processing system for playing multiple types of audio and video media, comprising:
devices capable of playing audio and video;
a display device; and
a processor device operatively coupled to the devices and the display device capable playing a sequence of media on different audio and video devices corresponding to a multimedia playlist having a list of media.

12. The apparatus of claim 11 further comprising a database having additional information corresponding to an audio or video media.

13. The apparatus of claim 11 wherein the multimedia playlist further comprises:
a list of media playable on different media playback devices;
a first entry of media in the multimedia playlist for playback on a first type of media playback device; and
a subsequent entry of media in the multimedia playlist for playback on a second type of media playback device.

14. The devices in claim 11 wherein at least one device is capable of playing a compact disk (CD).

15. The devices in claim 11 wherein at least one device is capable of playing a video tape.

16. The devices in claim 11 wherein at least one device is capable of playing a digital video.

17. A computer-readable medium containing instructions executable on a processor that generates a list of media for playback from different types of audio and video media, the method comprising the steps of:
identifying a list of different types of media available for playback;
displaying the list of media; and
receiving a selection of media from the list of media to playback audio or video.

18. The computer-readable medium of claim 17 wherein the instructions that identify a list of different types of media further include instructions capable of:
determining what devices are associated with the data processing system;
extracting unique data from media loaded in the devices; and
generating an identifier from the unique data stored on each media.

19. The computer-readable medium of claim 17 further including instructions capable of locating additional information on each media based upon the identifier.

20. The computer-readable medium of claim 19 wherein the additional information includes the title of the media.

21. The computer-readable medium of claim 19 wherein the additional information includes a list of people performing on the media.

22. The computer-readable medium of claim 19 wherein the step of displaying the list of media also includes displaying the additional information on each media.
